(19) United States
(12) Patent Application Publication
(10) Pub. No.: US 2026/0279950 A1
(43) Pub. Date: Sep. 17, 2026

(54) FLOTATION DEVICE FOR THERMAL RUNAWAY MANAGEMENT

(71) Applicant: Volvo Truck Corporation, GÖTEBORG (SE)

(72) Inventors: Fredrik LINDELÖW, SKÖVDE (SE); Tobias TINGBERG, Mölnlycke (SE)

(21) Appl. No.: 19/564,672

(22) Filed: Mar. 12, 2026

(30) Foreign Application Priority Data
Mar. 13, 2025 (EP) 25163517

(51) Int. Cl. H01M 10/63; H01M 10/613; H01M 10/625; H01M 10/6552; H01M 10/6567

(52) U.S. Cl. CPC H01M 10/63; H01M 10/613; H01M 10/625; H01M 10/6552; H01M 10/6567; H01M 2200/10; H01M 2220/20

(57) ABSTRACT

As disclosed herein, a flotation device includes a first portion arranged in fluid communication with liquid coolant accommodated by a liquid coolant pipe, the first portion causing selective blocking or opening of an outlet leading inside a battery pack; a second portion arranged inside the battery pack being floatable; and a third portion interconnecting the portions, wherein the third portion is configured to adjust a position of the first portion based on a position of the second portion.

### CROSS REFERENCE TO RELATED APPLICATIONS

1. This application claims priority to European Patent Application 25163517, filed on Mar. 13, 2025, the disclosure and content of which is incorporated by reference herein in its entirety.

### TECHNICAL FIELD

2. The disclosure relates generally to thermal runaway management. In particular aspects, the disclosure relates to a flotation device for thermal runaway management. The disclosure can be applied to heavy-duty vehicles, such as trucks, buses, and construction equipment, among other vehicle types. The disclosure can also be applied to other areas of application, such as marine vessels, industrial applications, stationary applications, among other areas of application. Although the disclosure may be described with respect to a particular area of application, the disclosure is not restricted to any particular area of application.

### BACKGROUND

3. With the recent focus on electric vehicles and devices as an alternative to fossil fuels, more and more battery packs are being used. Such battery packs may fail and overheat in a thermal runaway. This may in turn cause a chain reaction as the thermal runaway can spread to adjacent battery packs.

### SUMMARY

4. A liquid coolant that comes into contact with a terminal circuit may lead to the liquid coolant being subjected to chemical decomposition which can cause a buildup of hydrogen gas. The prior art fails to suggest a satisfactory solution for managing thermal runaway events, and especially where thermal runaways trigger chain reactions of uncontrolled thermal runaways that cascade among a plurality of battery modules. A flotation device is employed herein that aims to manage a height level of liquid coolant released into the battery pack when a thermal runaway event occurs.

5. In a first aspect of the disclosure there is accordingly provided a flotation device attached to a liquid coolant pipe of a battery pack having one or more battery modules, the flotation device comprising: a first portion arranged in fluid communication with liquid coolant accommodated by the liquid coolant pipe, the first portion causing selective blocking or opening of an outlet leading inside the battery pack; a second portion arranged inside the battery pack and being floatable; and a third portion interconnecting the first and second portions, wherein the third portion is configured to adjust a position of the first portion based on a position of the second portion.

6. The first aspect of the disclosure may seek to prevent coolant overflow and protect sensitive battery components during a thermal runaway event. A technical benefit may include enhancing safety and height level control by ensuring the coolant level is precisely managed, preventing damage and improving system reliability.

7. In some embodiments, the third portion adjusts the position of the first portion to physically block the outlet. A technical benefit may include a reliable mechanical method to block the outlet, ensuring immediate response to coolant overflow.

8. In some embodiments, further comprising an electronic switch, wherein the third portion adjusts the position of the first portion to activate said electronic switch to trigger a block of the outlet. A technical benefit may include allowing integration with electronic systems for precise and automated control of the outlet blockage.

9. In some embodiments, further comprising a pipe extension portion, wherein the first portion, the outlet, and at least parts of the third portion is arranged in the pipe extension portion. A technical benefit may include improving spatial organization and facilitating maintenance by consolidating key components within the pipe extension.

In some embodiments, wherein the pipe extension portion is retrofitted to the liquid coolant pipe such that an opening for liquid coolant is formed at an end of the pipe extension portion. A technical benefit may include enabling easy adaptation to existing systems, allowing for straightforward retrofitting and enhanced functionality.

In some embodiments, further comprising an actuator configured to control the release of liquid coolant through the outlet. A technical benefit may include offering precise control over coolant release, enhancing the responsiveness to thermal conditions.

In some embodiments, wherein the actuator is configured to be controlled by a battery management system of the battery pack based on battery data indicating the presence of the thermal runaway event. A technical benefit may include allowing the system to respond intelligently to real-time battery data, improving safety and efficiency.

In some embodiments, wherein the actuator comprises a fusible material having a melting point or sublimation point corresponding to a temperature threshold. A technical benefit may include providing a fail-safe mechanism that automatically triggers coolant release at critical temperatures.

In some embodiments, wherein the outlet comprises a fusible material having a melting point or sublimation point corresponding to a temperature threshold. A technical benefit may include providing a fail-safe mechanism that automatically triggers coolant release at critical temperatures.

In some embodiments, wherein the second portion comprises a material having a density lower than that of the liquid coolant. A technical benefit may include enhancing buoyancy control to maintain effective management of the coolant level.

In some embodiments, wherein the second portion comprises an elongated member having a lower surface that is generally planar with a surface of said released liquid coolant. A technical benefit may include enhancing buoyancy control to maintain effective management of the coolant level.

In some embodiments, wherein the outlet comprises a controllable hatch movable between a blocking state and an open state. A technical benefit may include allowing for dynamic control of the coolant flow, adapting to various operational states.

In some embodiments, wherein the outlet is arranged below a terminal circuit of a lowest battery module from among the one or more battery modules. A technical benefit may include reducing risk by positioning the outlet to avoid contact with sensitive circuitry.

In some embodiments, wherein the outlet is arranged adjacent to a bottom of the battery pack. A technical benefit may include improving coolant dispersion and reducing the risk of damage by positioning the outlet near the battery pack’s bottom.

In a second aspect of the disclosure there is provided a method for thermal runaway management, comprising: accommodating liquid coolant in a liquid coolant pipe of a battery pack having one or more battery modules; attaching a flotation device to the liquid coolant pipe, wherein the flotation device comprises a first portion arranged in fluid communication with liquid coolant accommodated by the liquid coolant pipe, the first portion causing selective blocking or opening of an outlet leading inside the battery pack, a second portion arranged inside the battery pack and being floatable, and a third portion interconnecting the first and second portions, wherein the third portion is configured to adjust a position of the first portion based on a position of the second portion.

The second aspect of the disclosure may seek to prevent coolant overflow and protect sensitive battery components during a thermal runaway event. A technical benefit may include enhancing safety and height level control by ensuring the coolant level is precisely managed, preventing damage and improving system reliability.

The disclosed aspects, examples, and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary schematic illustration of an electric vehicle according to an example.

FIG. 2 is an exemplary schematic illustration of a battery pack comprising liquid coolant pipes, according to an example.

FIG. 3A is an exemplary schematic illustration of a flotation device attached to a liquid coolant pipe under normal operating conditions, i.e., when a thermal runaway event has not yet occurred, according to an example.

FIG. 3B shows the flotation device of FIG. 3A in a more zoomed in view including components of the flotation device.

FIG. 4A is an exemplary schematic illustration of a flotation device attached to a liquid coolant pipe under excessive temperature conditions, i.e., when a thermal runaway event has occurred, and some coolant has been released into the battery pack, according to an example.

FIG. 4B shows the flotation device of FIG. 4A in a more zoomed in view including components of the flotation device.

FIG. 5A is an exemplary schematic illustration of a flotation device attached to a liquid coolant pipe under excessive temperature conditions, i.e., when a thermal runaway event has occurred, and the liquid level in the battery pack has reached the height of the second portion of the flotation device and caused some movement thereof, according to an example.

FIG. 5B shows the flotation device of FIG. 5A in a more zoomed in view including components of the flotation device.

FIG. 6A is an exemplary schematic illustration of a flotation device attached to a liquid coolant pipe under excessive temperature conditions, i.e., when a thermal runaway event has occurred, and the liquid level in the battery pack has reached the height of the second portion of the flotation device and caused further movement thereof, according to an example.

FIG. 6B shows the flotation device of FIG. 6A in a more zoomed in view including components of the flotation device.

FIG. 7 is another exemplary schematic illustration a flotation device according to an example.

FIG. 8 is another exemplary schematic illustration a flotation device according to an example.

FIG. 9 is another exemplary schematic illustration a flotation device according to an example.

FIG. 10 is an exemplary block diagram illustration of a method for thermal runaway management, according to an example.

### DETAILED DESCRIPTION

The detailed description set forth below provides information and examples of the disclosed technology with sufficient detail to enable those skilled in the art to practice the disclosure.

The general concept as defined herein in the respective aspects of the disclosure may be applicable to battery packs of any stationary or moveable unit. Such units may for example be generators, vehicles, handheld devices or the like. In the context of the present disclosure, examples will sometimes be presented relating to a battery pack in an electric vehicle (EV). It should however be noted that any unit possessing a battery pack that can experience thermal runaway may utilize the disclosed technology.

A thermal runaway is a process where an increase in the temperature of a battery or battery pack changes the conditions therein such that a further, uncontrolled, temperature increase is caused. This temperature increase may be started for a number of reasons. For example it may be caused by overcharging or undercharging of the battery pack, a short circuit caused by physical damage, chemical reactions, insufficient cooling, incorrect mixing of battery reactants, pressure buildup in the battery pack, high current loads, and so forth. The thermal runaway may also further damage other battery packs in close proximity, for example due to melting of materials, causing a further thermal runaway event. In this manner, a thermal runaway may spread throughout a battery pack, a high voltage component, or an energy storage system, thereby causing multiple thermal runaway events. While a “thermal runaway” refers to a self-accelerating condition where an increase in temperature causes further increases, potentially leading to destructive outcomes, a “thermal runaway event” specifically denotes the occurrence or instance of this uncontrolled process resulting in damage or failure.

A battery pack is often equipped with coolant pipes accommodating liquid coolant. The liquid coolant is introduced to the battery pack in order to decrease or eliminate the effects of the thermal runaway in the single battery pack, or to decrease or eliminate the risk that the thermal runaway spreads as described above. However, it is envisaged that the release of such a liquid coolant may encounter circuitry inside the battery packs. This could lead to chemical decomposition leading to hydrogen gas buildup, thus further damaging the battery pack. The subject matter of this disclosure thereby seeks to mitigate the above-described negative effects by managing a height level of the of released liquid coolant. This is done by way of attaching a flotation device to one or more existing liquid coolant pipes in the battery pack.

The flotation device includes three main components: a first portion, a second portion, and a third portion. The first portion is designed to selectively cause blockage or opening of an outlet in the liquid coolant pipe, controlling the flow of coolant that enters the battery pack. The second portion is a member inside the battery pack that floats on the surface of the released liquid coolant. The third portion interconnects the first and second portions, enabling a feedback loop by way of the third portion adjusting the position of the first portion based on a position of the second portion. This loop ensures precise control over the coolant level by causing the second portion to float as the liquid level rises, which in turn moves the third portion to adjust the position of the first portion in relation to the outlet. This prevents the coolant from reaching sensitive battery circuitry. Conversely, as the coolant evaporates due to excessive heat, the flotation device allows more coolant to enter the battery pack safely. This dynamic system maintains the desirable coolant level, ensuring safety and efficiency by automatically responding to changes in the liquid level.

The problems referred to above concerning effectively managing thermal runaway events in battery packs can accordingly be solved. This may offer technical benefits relating to a careful control of liquid coolant volume in the battery pack based on the specific layout of the battery cell configuration, ensuring safe containment and effective cooling while mitigating the risk of dangerous incidents such as explosions. This ultimately offers an increased safety and reliability in the event of thermal runaway.

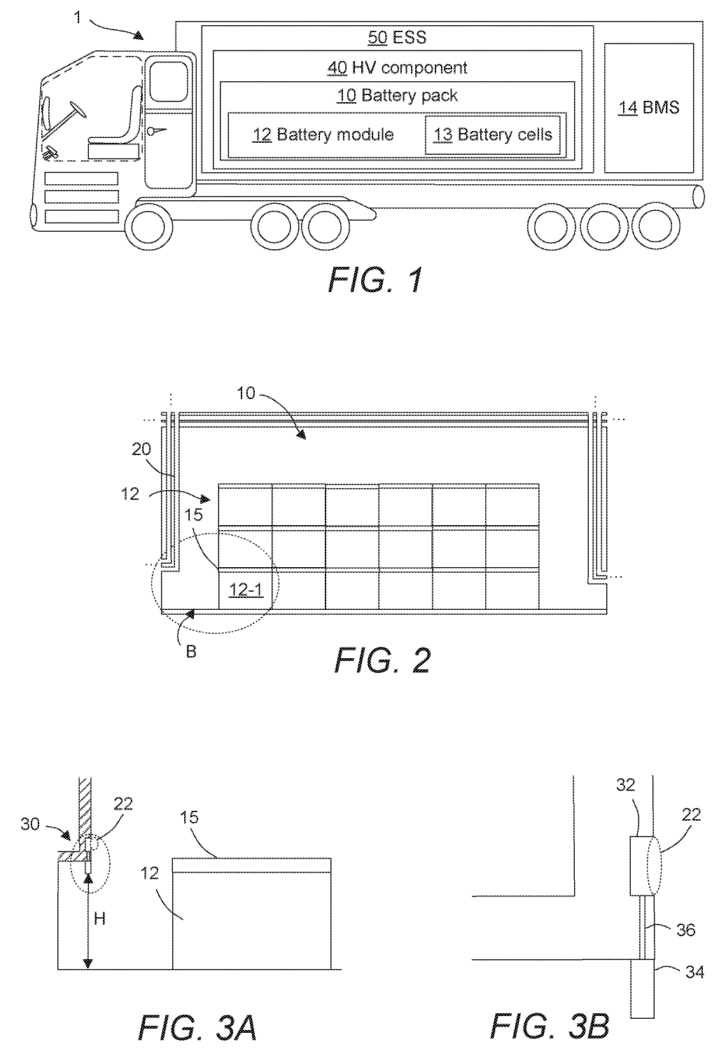

FIG. 1 is an exemplary schematic illustration of a vehicle 1. The vehicle 1 is illustrated as a heavy-duty vehicle, in this case a truck. The vehicle 1 may be an electric vehicle. In other areas of application other machines typically employing battery systems can be envisaged, such as for buses, marine vessels, construction equipment, personal vehicles, consumer electronics such as smartphones or tablets, home battery storage systems, grid storage systems, drones, satellite systems, portable medical equipment, vacuums, among other areas of application. Essentially, any type of battery using a unit that may experience thermal runaway is an exemplary area of application.

The vehicle 1 comprises an energy storage system, ESS 50. The ESS 50 is arranged to store electrical energy and release it as needed. The ESS 50 may comprise a high-voltage, HV, component 40. The HV component 40 is a relative term, and what is considered high voltage may depend on the context. In applicable power systems discussed herein, high voltage typically refers to voltages higher than the standard residential or commercial power distribution levels. Purely by way of example, voltage levels for HV components in traction batteries or fuel cell systems typically range between 200 V and 800 V or more, in DC fast chargers between 600 V and 1000 V, in HEV (Hybrid Electric Vehicles) between 200 and 300 V. The skilled person will appreciate that the voltage level for the HV component 40 is readily adaptable for other HV application areas.

The HV component 40 – or the EES 50 – may comprise a plurality of battery packs 10, each battery pack 10 having one or more battery modules 12. The battery modules 12 each carry a set of battery cells 13 responsible for storing energy in chemical form. When chemical reactions occur, electrical energy is harnessed for various application. The battery cell 13 is the fundamental building block of a battery, comprising an anode, cathode, and electrolyte. Multiple battery cells 13 are combined to create a battery module 12. A battery module 12 can carry further components that enable interaction between battery modules 12, such as communications units and connectors. Multiple battery modules 12 may in turn be combined to create a battery pack 10, a modular unit that delivers voltage, capacity, and power for diverse applications. The battery packs 10 may include lithium-ion batteries, lithium iron phosphate batteries, solid-state batteries, graphene batteries, sodium-ion batteries, nickel-cobalt-manganese batteries, aluminum-ion batteries, or other battery types known in the art. The battery packs 10 are rechargeable and adapted to provide a source of electricity for an electric propulsion system (not shown). The battery packs 10 are often arranged in close proximity to one another. The battery modules 12 are often arranged in close proximity to one another inside the battery pack 10.

The vehicle 1 may comprise a battery management system, BMS 14, operating in tandem with the ESS 50 by monitoring and managing the individual battery cells 13 within the battery packs 10. Typically, each battery pack 10 is associated with a BMS controller. Alternatively, the BMS 14 may include a master controller configured to monitor and manage a plurality of battery packs 10. The BMS 14 may handle functions such as balanced charging and discharging, prevention of overcharging or over-discharging, management of temperatures, and optimizations of overall performance and/or safety. The BMS 14 may decrease or increase the current flowing to and from a battery cell 13 in order to control the temperature therein.

FIG. 2 is an exemplary schematic illustration of a battery pack 10 according to examples disclosed herein. A plurality of modules and elements are arranged inside the battery pack 10. The battery pack 10 comprises one or more battery modules 12, in this particular example 18 battery modules 12. The battery module 12 provides voltage to the HV component 40 mentioned above. In examples where multiple battery modules 12 are arranged in the battery pack 10, they may be arranged side-by-side, above one another, or practically anywhere suitable inside of the battery pack 10. However, one (or possible more) battery modules 12-1 are arranged closest to the bottom B of the battery pack 10. In some examples, the lowest battery module 12-1 is arranged at the bottom B of the battery pack 10. In some further examples, multiple battery modules 12-1 are arranged at about the same height level, closest to the bottom B. The person skilled in the art will understand that whichever battery module(s) 12-1 is arranged closest to the bottom B of the battery pack 10, out of all battery modules 12 in the battery pack 10, may be interpreted as a lowest battery module 12-1. The lowest battery module 12-1 is thus the bottommost module or modules in relation to the bottom B of the battery pack 10.

Each battery module 12 may comprise a number of exposed circuits. In the current disclosure, reference will be made to a terminal circuit 15. The terminal circuit 15 is any piece of electric circuitry that, if it encounters a liquid, could cause chemical decomposition of the liquid, or which could be damaged by the liquid. For example, the terminal circuitry 15 could be fuses, wires, connectors, conductors, or exposed metal films, to name a few examples. In general, a terminal circuit 15 could be any piece of the battery module 12 in which electrical current is flowing, and which is exposed to an environment in the inside of the battery pack 10. The terminal circuit 15 is typically any such piece of circuitry that is arranged closest to the bottom B within the battery pack 10, i.e., the terminal circuit 15 closest to the bottom B among all other terminal circuitry in the battery pack 10.

The battery pack 10 comprises a liquid coolant pipe 20. In prior art systems, the liquid coolant pipe 20 is primarily used for passive cooling, helping to maintain desirable temperature conditions by circulating coolant around battery cells 13. In the present disclosure, these existing pipes 20 are repurposed to actively release liquid coolant inside the battery pack 10 during a thermal runaway event. This use allows the liquid coolant to directly manage overheating by being introduced in the inside of the battery pack 10.

In the example provided, the pipes 20 are arranged along the sides and ceiling of the battery pack 10, but their configuration can vary. They might be integrated within the walls, floor, or even interwoven between battery modules 12, depending on the specific design and requirements of the battery pack 10.

The liquid coolant pipes 20 accommodate a liquid coolant, i.e., having a capacity to hold and transport liquid coolant, ready to release it as needed to control temperature and prevent damage to the battery pack 10. The liquid coolant typically includes water, which is advantageous due to its suitable vapour point and the high energy required for vaporization, making it effective for cooling. In some examples, the coolant might also include an antifreeze, especially in cold climates or environments with low temperatures, such as freezers. Antifreeze prevents the coolant from freezing, which is useful for two main reasons: it ensures the continuous flow of coolant into the battery pack’s 10 interior, and it prevents potential damage to the housing caused by the expansion of the coolant when it freezes.

The dotted portion in FIG. 2 will now be further explained in detail, with reference to the example of FIG. 3A. An exemplary flotation device 30 is introduced here, attached to the liquid coolant pipe 20. FIG. 3A shows the battery pack 10 operating under normal operating conditions, i.e., when a thermal runaway event has not yet occurred.

The terminal circuit 15 requires protection from liquid exposure while still needing efficient cooling during a thermal runaway event. Currently, no such event has occurred, and the flotation device 30 attached to the coolant pipe 20 operates in a so called non-active mode, effectively blocking an outlet 22 of the pipe 20 that leads into the battery pack 10. The non-active mode may also be referred to as a passive mode.

The outlet 22 is designed to allow liquid flow from the coolant pipe 20 into the battery pack 10 when needed. The outlet 22 can be created through various manufacturing techniques such as drilling or etching and may also be connected via a fluid connector like a pipe or tube. In some examples, the outlet 22 may be placed below the terminal circuit 15 to limit the risk of coolant splashing onto sensitive components. In some examples, the outlet 22 may be arranged adjacent to the bottom B to make the release and distribution of the coolant safer.

The outlet 22 may be partially covered by an openable seal, which acts as a barrier to control the release of liquid coolant. In some examples, the outlet 22 is completely covered by the seal, ensuring no leakage until activation. The seal can also secure a cover made of materials like copper, steel, or ceramic, designed to melt or sublimate at temperatures typical of a thermal runaway event. In some examples, the outlet 22 is equipped with a seal made from a fusible material with a melting or sublimation point between 100-300 ℃, such as silicone, ceramics, metals, or polymers like polyamide. The material choice may vary based on the battery pack’s 10 operational context. The outlet 22 may also have a seal made from wax materials, such as polytetrafluoroethylene, beeswax, carnauba wax, or paraffin wax, which respond to high temperatures by melting and allowing coolant flow. These designs ensure that when the seal opens, the liquid coolant can effectively flow into the battery pack 10, managing heat and preventing damage to sensitive components.

As mentioned previously, the terminal circuit 15 can interact in dangerous or harmful ways with a liquid coolant. For example, water may be subjected to chemical decomposition, producing hydrogen gas. Such hydrogen gas in a high-temperature environment, such as the environment prevailing in the case of a thermal runaway, can cause explosions. Furthermore, a liquid coolant may damage the terminal circuit 15. It has therefore been realized that the need to carefully manage the height that the released coolant is allowed to reach within the battery pack 10 before the outlet 22 needs to be blocked again. This height is in this disclosure referred to as height level H, and it can be determined based on how the flotation device 30 is designed. The height limit H is a limit below the terminal circuit 15, as is shown in FIG. 3A.

It should be noted that terminal circuitry is typically present on all of the battery modules 12 in the battery pack 10. However, the height limit H is primarily relevant for the terminal circuit 15 located the closest to the bottom B. This is because any terminal circuit 15 positioned above the this terminal circuit 15, whether on the same lowest battery module 12-1 or another battery module 12, will only be submerged after the lowest terminal circuit 15 has been submerged. This naturally occurs because the liquid is released to the bottom B and rises upwards. Therefore, the focus is directed at the lowest terminal circuit 15. By managing liquid coolant submersion with respect to the lowest terminal circuit 15, liquid coolant submersion will consequently also be managed for all the other terminal circuit 15 of the same battery pack 10 due the way the liquid coolant rises in the battery pack 10. This approach is advantageous as it ensures that all critical components are protected, thereby providing a controlled and effective method for managing thermal runaway.

In some examples, the height limit H is a measurable limit, for example in centimeters, that stretches from the bottom B of the battery pack 10 to the bottom of the terminal circuit 15 or specific sensitive or conductive parts on the terminal circuit 15. The flotation device 30 is designed accordingly, namely set at about the same height or slightly lower (such as a few centimeters). For example, a housing spanning for some length holding the sensitive or conductive parts in place can in some examples be submerged in liquid coolant, while making sure the sensitive or conductive parts are not exposed to liquid.

The dotted portion of FIG. 3A is shown in more detail in FIG. 3B, and reference is made thereto in the following. The flotation device 30 includes three central portions, here referred to as a first portion 32, a second portion 34, and a third portion 36. The flotation device 30 is here positioned in a first end position (also a “highest position”).

The first portion 32 is designed to be in fluid communication with the liquid inside the coolant pipe 20, meaning it is capable of responding to changes in coolant pressure or flow requirements. The first portion 32 acts as a gatekeeper for the outlet 22, allowing or restricting the flow based on whether a thermal runaway event is ongoing or not. In this passive mode, the first portion 32 completely covers the outlet 22, preventing any coolant from entering the battery pack 10. This coverage ensures that coolant is only released when necessary, maintaining the integrity and safety of the battery pack 10. The design of the first portion 32 can vary widely.

While shown here as a rectangular shape, it could also be circular, oval, or any irregular form, provided it effectively can cause blockage of the outlet 22. It might be a flexible membrane that molds to contours of the outlet 22 or a rigid cap that securely fits over it. The size can also vary, from a small plug-like structure to a larger panel, depending on the dimensions of the outlet 22 and cooling requirements.

The first portion 32 is in this example arranged inside the coolant pipe 20, but it is not necessarily the case provided it can cause blockage of the outlet 22. In other examples it could be moved to activate a switch that closes a hatch, or the like.

The first portion 32 might be made from various materials, such as polymers, metals, or composite materials, chosen for their durability, heat resistance, and compatibility with the coolant. This adaptability in shape, size, and material ensures that the first portion 32 can be tailored to fit different battery pack configurations, tailoring its functionality across various designs and applications.

The first portion 32 is depicted here as being arranged inside the coolant pipe 20, directly covering the outlet 22 to block coolant flow. However, this arrangement is not the only possibility. The primary requirement is that it must cause blockage of the outlet 22, regardless of its specific location or mechanism. In alternative designs, the first portion 32 could be positioned outside the pipe 20, connected to e.g. a lever, actuator or other member that triggers a mechanism to close the outlet 22. For instance, it could be linked to a switch that activates a sliding or rotating hatch, sealing the outlet 22 when no coolant release is needed. Yet alternatively, the first portion 32 might be part of a more complex system involving gears or cams that engage when the first portion moves, causing a physical barrier to slide into place over the outlet 22.

The second portion 34, also referred to as a floating portion, is a component designed to maintain buoyancy on the liquid coolant as it fills the battery pack 10. This buoyancy occurs when the coolant reaches the height level H, aligned with the second portion 34, allowing it to rise with the liquid surface. This has not yet occurred in the shown example due to the flotation device 30 operating in its passive mode. Typically, the second portion 34 would be arranged external to the coolant pipe 20 such that it can float on the released liquid. In some examples, some parts of the second portion 34 could be arranged inside the coolant pipe 20, while other parts could be arranged external to the coolant pipe 20.

The second portion 34 may comprise materials that ensure it remains buoyant, typically with a density lower than that of the liquid coolant. Such materials can include lightweight plastics, foams, or air-filled chambers. These materials enable it to float effectively without adding significant weight to the system.

In some designs, the second portion 34 could include an elongated member having a lower surface that is generally planar with a surface of said released liquid coolant. This may resemble a broad, flat disc, improving surface contact with the coolant for stable floating. Alternatively, it might take the form of a cylindrical buoy or a spherical float, offering flexibility in movement and stability. The second portion 34 may also incorporate features like stabilizing fins or a weighted bottom to ensure it remains upright and responsive, even if the battery pack 10 is subject to vibrations or tilting. This would be more likely in mobile areas of application, such as vehicles.

The third portion 36 acts as a link between the first portion 32 and the second portion 34, putting the flotation device 30 together in an integrated system that responds dynamically to changes in the liquid coolant level. This interconnection can take several forms, depending on the specific design requirements and operational conditions of the battery pack 10.

The third portion 36 may be a rigid rod or lever that physically connects the floating second portion 34 to the first portion 32. As the second portion 34 rises with the coolant, the rod transfers this motion to the first portion 32, causing it to adjust its position and either block or open the outlet 22. Alternatively, the third portion 36 could be a flexible cable or chain-like member, providing a more adaptable connection that can accommodate complex movements or layouts within the battery pack 10. This flexibility allows for smoother transitions and can be beneficial in systems where space is limited or configurations are non-linear. In other variations, the third portion 36 might incorporate a series of gears or pulleys, translating the vertical movement of the second portion 34 into a horizontal or diagonal adjustment of the first portion 32. This mechanical advantage can enhance precision and control, ensuring accurate responses to changes in coolant level.

While the portions 32, 34, 36 are above described as separate units, it shall be understood that they may form part of an integrated unit in some examples. This integrated unit may include a lower portion representing the second portion 34, a middle portion representing the third portion 36, and an upper portion representing the first portion 32. For example, it may be a single block capable of bobbing on a surface of a liquid coolant to selectively cause blockage of the outlet 22. Depending on design requirements, the various portions may have any length making up the total length of the single block (e.g. 10%, 80%, 10%; or 33%, 33%, 33%; or 90%, 5%, 5%; or practically any suitable length distribution).

The movement of the flotation device 30 discussed herein is explained as a vertical displacement along the height of the battery pack 10, although other types of movements can be envisaged, including but not limited to rotational movements, where the device 30 pivots around a fixed point, lateral movements, where the device 30 slides horizontally, or angular adjustments, where the device 30 tilts in response to the coolant level, offering versatile solutions for various battery pack designs and configurations.

The relationship between the portions 32, 34, 36 forms a cohesive feedback loop. As the second portion 34 floats and moves with the coolant level, the third portion 36 transfers this movement to the first portion 32. This results in the first portion 32 adjusting its position to maintain the coolant level at the desired height limit H, preventing excess coolant from reaching the terminal circuit 15. This feedback loop may also be useful where natural condensation of the coolant occurs due to the high temperatures within the battery pack 10. As the coolant evaporates to cool the system, it condenses and reduces in volume, allowing the second portion 34 to lower. This change is detected by the third portion 36 in response to a height drop of the second portion 34, which consequently adjusts the first portion 32 to permit additional coolant inflow. This continuous adjustment ensures the coolant level remains as desired, effectively managing thermal conditions while preventing excess liquid from reaching the terminal circuit 15.

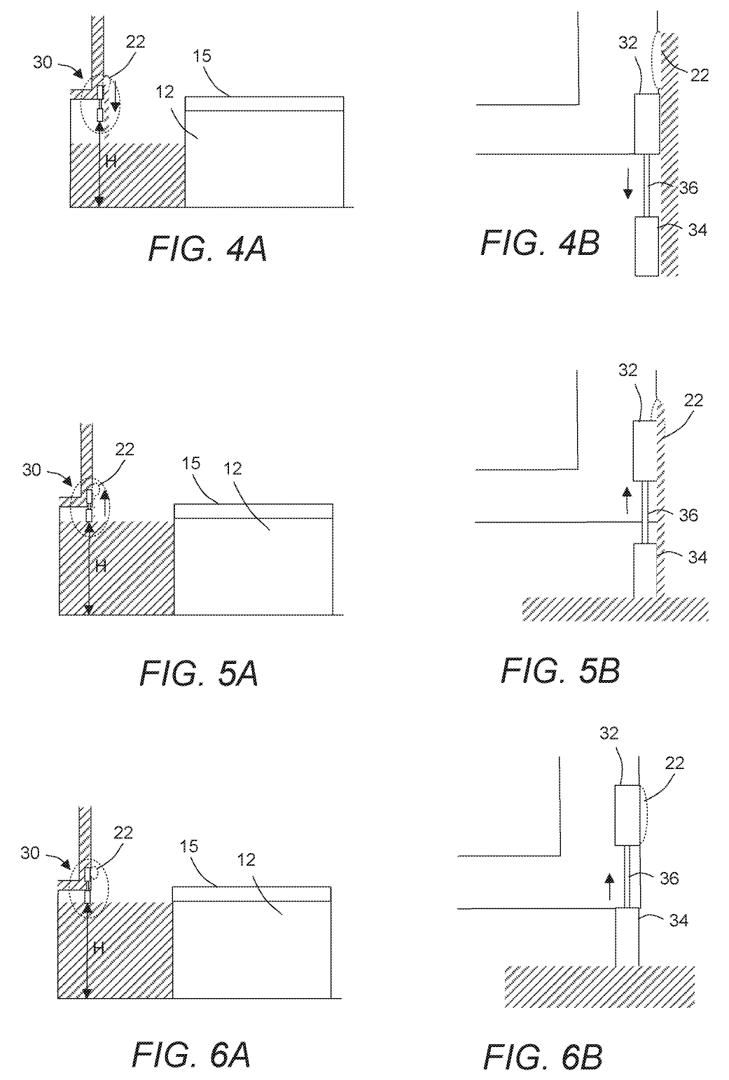

In FIGS. 4A-B, a continuation of FIGS. 3A-B is shown. Here, the battery pack 10 experiences excessive temperature conditions due to a thermal runaway event. This triggers the release of coolant into the battery pack 10 to manage and reduce the heat. The coolant flows through the outlet 22 from the coolant pipe 20 and fills the battery pack 10 up towards the height limit H, as shown in the figures. The flotation device 30 is thus positioned in its second end position (also a “lowest position”).

The actuation of liquid release can occur through several mechanisms. Temperature sensors within the battery pack 10 and/or the BMS 14 can detect rising heat levels, signaling the device to release coolant once a temperature and/or voltage threshold limit is reached. Alternatively, the outlet 22 may include a fusible material that melts at high temperatures, triggering a mechanical action to open the outlet 22. Pressure sensors can also be arranged in the battery pack 10, and as internal pressure builds due to the heat, exceeding a pre-set limit can activate the trigger of the liquid actuation. Other mechanical triggers, such as bimetallic strips or thermal expansion elements, could also be used, where differential expansion due to heat causes release of liquid.

FIGS. 5A-B show a continuation of the example of FIGS. 4A-B. Here, the released liquid has reached the height limit H corresponding to that of the second portion 34 of the flotation device 30. The buoyancy of the second portion 34 thus causes a push of the flotation device 30 upwards, transferring motion from the second portion 34 to the first portion 32 via the third portion 36. The flotation device 30 is still in an active mode due to the thermal runaway event being ongoing. However, the outlet 22 is partially obstructed by the movement of the first portion 32. Liquid will thereby not be released with the same velocity, as the area of an open portion of the outlet 22 is smaller compared to when the height level of the released liquid is lower.

FIGS. 6A-B show a continuation of the example of FIGS. 5A-B. Here, the released liquid has continued to push the second portion 34 upwards to the first end position (“highest position”) again. The flotation device 30 is still in an active mode because the thermal runaway event is still ongoing, but the outlet 22 is blocked due to the buoyancy of the second portion 34.

To summarize the procedure explained in FIGS. 3A to FIG. 6B above, the following can be envisaged. The flotation device 30 is capable of assuming one of two modes: a passive mode and an active mode. The position of the first portion 32 is adjustable by the third portion 36 based on a position of the second portion 34. In the passive mode, the outlet 22 is in a blocked state, where the first portion 32 causes blockage of the outlet 22, for example by a physical block. In the active mode, the outlet 22 enters an unblocked state, for example by a rupturing of a fusible material. The accommodated liquid coolant is thus released through the outlet 22. When the released liquid coolant inside the battery pack 10 reaches a height level H corresponding to that of the second portion 34, the position of the second portion 34 inherently changes thanks to its buoyancy feature. By way of the interconnection between the first and second portions 32, 34 via the third portion 36, this will make the third portion 36 adjust the position of the first portion 32. The state of the outlet 22 will thereby shift from the unblocked towards the blocked state. Since the thermal runaway event has already occurred, the purpose of the flotation device 30 has been served, so the passive state will not be re-entered again, albeit the coolant level inside the battery pack 10 is accurately controlled.

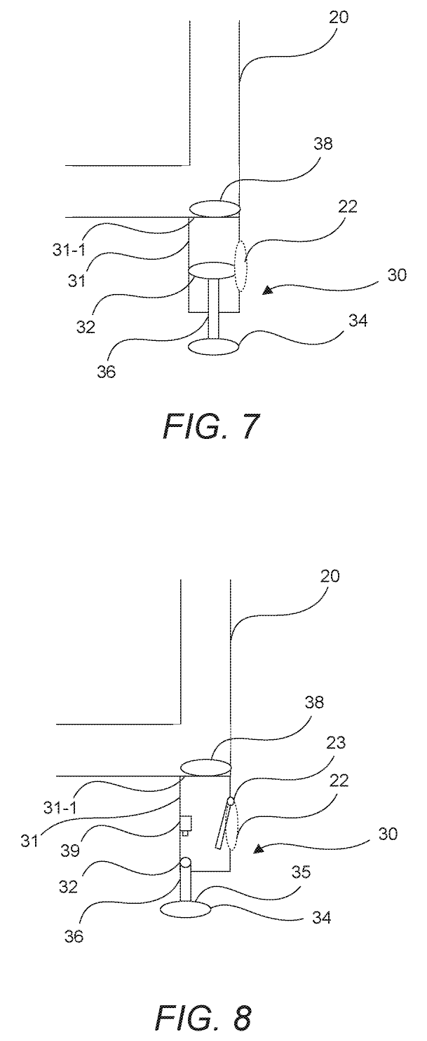

FIG. 7 shows an exemplary flotation device 30. A couple of additional components are introduced here, in addition to those explained above in FIGS. 3A-6B, involving an actuator 38 and a pipe extension portion 31.

The pipe extension portion 31 houses the first portion 32, the outlet 22, and parts of the third portion 36. The extent of parts of the third portion 36 housed by the pipe extension portion 31 depends on the vertical displacement of the flotation device 30, which in turn depends on liquid level in the battery pack 10. The pipe extension portion 31 serves as an additional chamber that integrates components to allow for more organized and efficient flow control. The pipe extension portion 31 acts as a dedicated space where the flotation device 30 can operate with limited interference from the main coolant pipe 20.

The pipe extension portion 31 can be retrofitted to the existing liquid coolant pipe 20. This retrofit creates an opening 31-1 at one end of the pipe extension portion 31 (in this illustration the upper end), allowing for the controlled flow of coolant into the battery pack 10. The retrofit design enables the integration of the flotation device 30 into existing systems with little modifications required to be made to the original coolant pipe 20. This flexibility in design makes it adaptable to various spatial constraints within the battery pack 10. The pipe extension portion 31 can be shaped and sized to fit different configurations, both of the pipe 30 and of the battery pack 10, offering a versatile solution that can accommodate non-standard layouts or tight spaces, rather than, for instance, just adhering to a rectangular form.

The actuator 38 is configured to control the release of liquid coolant through the outlet 22. This actuator 38 provides an additional layer of control, ensuring the coolant is released precisely when needed. By incorporating an actuator 38, the flotation device 30 can respond more dynamically to changes in the battery pack’s 10 thermal conditions. The actuator 38 can be programmed to react to specific triggers, such as temperature increases or pressure changes. This setup allows for a more refined management of coolant flow, reducing the risk of unnecessary coolant discharge and preserving the battery pack’s 10 integrity.

The actuator 38 may be fully integrated into the flotation device 30, creating a compact and efficient device. This integration may ensure that the actuator 38 works seamlessly with the other components of the flotation device 30 with low delay. By being part of the flotation device 30, the actuator 38 can more effectively coordinate the opening and closing of the outlet 22 based on real-time conditions, reducing the need for external connections or additional components which may ultimately simplify installation and maintenance. The integrated actuator 38 can be tailored to fit the specific design of the flotation device 30, ensuring compatibility and reliability.

The actuator 38 may be configured to be controlled by the BMS 14. This connection allows the actuator 38 to receive direct input from the BMS 14 monitoring battery data to detect thermal runaway events. By linking the actuator 38 to the BMS 14, the release of coolant can be precisely timed to coincide with actual thermal needs, leveraging existing battery infrastructure to enhance safety and performance.

Similar to the outlet 22, the actuator 38 may include a fusible material with a melting or sublimation point corresponding to a specific temperature threshold. This material is designed to react to excessive heat, melting or sublimating to trigger the release of coolant. By incorporating a fusible material, the actuator 38 provides an additional or alternative automatic, fail-safe mechanism for coolant release during a thermal runaway event.

In this example, the flotation device 30 uses the third portion 36 to move the first portion 32 into physical contact to block the outlet 22. This direct mechanical movement ensures that the outlet 22 is closed when the coolant level reaches a certain height level. The design allows for a straightforward and reliable method of preventing excess coolant from entering the battery pack 10, utilizing the buoyancy of the second portion 34 to drive the physical closure process.

FIG. 8 shows an exemplary flotation device 30. A couple of additional components are introduced here, in addition to those explained above in FIG. 7, involving a controllable hatch 23 moving between a blocking state and an open state, as well as an electronic switch 39. Here, the second portion 34 comprises an elongated member 35.

The electronic switch 39 is activated by the movement of the third portion 36 by way of the second portion’s 34 buoyancy. As the second portion 34 floats, the third portion 36 moves the first portion 32 to triggers the electronic switch 39, initiating a mechanism to control the hatch 23. The electronic switch 39 can be positioned at any suitable location within the battery pack 10, such as adjacent to the outlet 22, along the pipe extension portion 31, or near the actuator 38, as long as it can be effectively triggered by the floating of the second portion 34. Its placement is flexible, allowing it to be integrated into various configurations, ensuring it responds accurately to the movement initiated by the buoyancy of the second portion 34.

FIG. 9 shows another exemplary variant of the flotation device 30. This flotation device 30 includes the portions 31, 32, 34, 36 and the actuator 38. The main difference here is how the third portion 36 is formed. Since the terminal circuit 15 is arranged at a lower location relative the bottom B, the height limit H is thus adjusted to prevent the coolant level from rising above the terminal circuit 15. In this example the solution involves increasing the length of the third portion 36 such that the second portion 34 will start to float at a lower level. The extended third portion 36 can be designed as a longer rod, providing the necessary reach to engage the second portion 34 at a reduced height. Moreover, the third portion 36 may include telescopic features, allowing it to extend or retract as needed. This would offer additional flexibility, enabling the flotation device 30 to adjust dynamically to different battery pack configurations.

In examples of this disclosure, the flotation device 30 has been visualized generally in an “I”-shape. It shall be noted that this is just one specific example. Other configurations, such as an “L”-shape for the third portion 36, can be envisaged to accommodate different spatial and functional requirements. Additionally, the flotation device 30 could feature a “T”-shape (for example where the first portion 32 is either end of the upper part of the “T”, the second portion 34 being another end, and the third portion 36 interconnecting these ends), a “U”-shape, or a tilted “I”-shape at a suitably selected angle. Similarly, the outlet 22 need not be positioned on a lateral side of the coolant pipe 20; it can be arranged on a bottom side, with the first portion 32 designed to cover the outlet from below, or even an upper side with a third portion 36 that bends around the pipe 20 such that the second portion 34 can float. This may offer versatility in design to fit various battery pack 10 layouts.

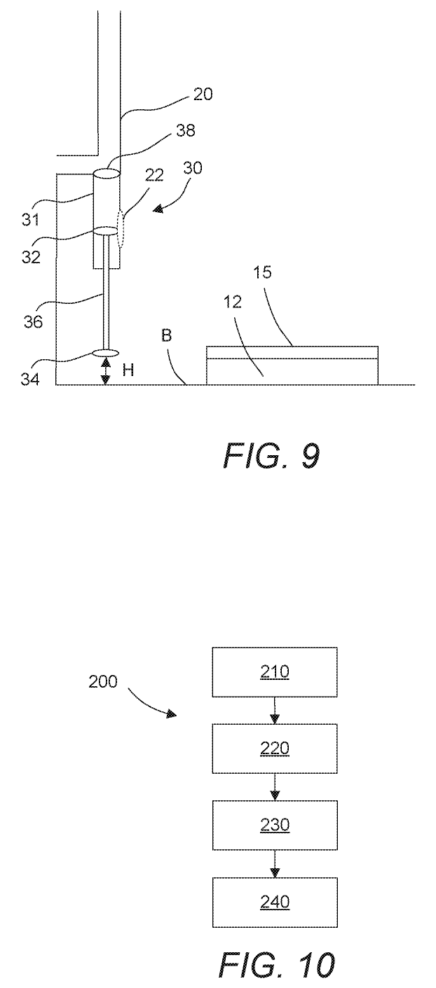

FIG. 10 is an exemplary flowchart of a method 200 for thermal runaway management. The method 200 comprises a step 210 of accommodating liquid coolant in a liquid coolant pipe 20 of a battery pack 10 having one or more battery modules 12. The method 200 further comprises a step 220 of attaching a flotation device 30 to the liquid coolant pipe 20. The flotation device 30 comprises a first portion 32 arranged in fluid communication with liquid coolant accommodated by the liquid coolant pipe 20, the first portion 32 causing selective blocking or opening of an outlet 22 leading inside the battery pack 10. The flotation device 30 comprises a second portion 34 arranged inside the battery pack 10 and being floatable. The flotation device 30 comprises a third portion 36 interconnecting the first and second portions 32, 34, wherein the third portion 36 is configured to adjust a position of the first portion 32 based on a position of the second portion 34.

In further examples of the disclosure the following examples can be envisaged.

Example 1: A flotation device (30) is attached to a liquid coolant pipe (20) of a battery pack (10) having one or more battery modules (12). The flotation device (30) comprises a first portion (32) arranged in fluid communication with liquid coolant accommodated by the liquid coolant pipe (20). This first portion (32) selectively blocks or opens an outlet (22) leading inside the battery pack (10). A second portion (34) is arranged inside the battery pack (10) and being floatable. A third portion (36) interconnects the first and second portions (32, 34). The third portion (36) is configured to adjust a position of the first portion (32) based on a position of the second portion (34).

Example 2: The flotation device (30) of Example 1, wherein the third portion (36) adjusts the position of the first portion (32) to physically block the outlet (22).

Example 3: The flotation device (30) of any preceding example, further comprising an electronic switch (39), wherein the third portion (36) adjusts the position of the first portion (32) to activate said electronic switch (39) to trigger a block of the outlet (22).

Example 4: The flotation device (30) of any preceding example, further comprising a pipe extension portion (31), wherein the first portion (32), the outlet (22), and at least parts of the third portion (36) are arranged in the pipe extension portion (31).

Example 5: The flotation device (30) of Example 4, wherein the pipe extension portion (31) is retrofitted to the liquid coolant pipe (20) such that an opening (31-1) for liquid coolant is formed at an end of the pipe extension portion (31).

Example 6: The flotation device (30) of any preceding example, further comprising an actuator (38) configured to control the release of liquid coolant through the outlet (22).

Example 7: The flotation device (30) of Example 6, wherein the actuator (38) is integrated into the flotation device (30).

Example 8: The flotation device (30) of any of Examples 6-7, wherein the actuator (38) is configured to be controlled by a battery management system (14) of the battery pack (10) based on battery data indicating the presence of the thermal runaway event.

Example 9: The flotation device (30) of any of Examples 6-8, wherein the actuator (38) comprises a fusible material having a melting point or sublimation point corresponding to a temperature threshold.

Example 10: The flotation device (30) of any preceding example, wherein the outlet (22) comprises a fusible material having a melting point or sublimation point corresponding to a temperature threshold.

Example 11: The flotation device (30) of any preceding example, wherein the second portion (34) comprises a material having a density lower than that of the liquid coolant.

Example 12: The flotation device (30) of any preceding example, wherein the second portion (34) comprises an elongated member (35) having a lower surface that is generally planar with a surface of said released liquid coolant.

Example 13: The flotation device (30) of any preceding example, wherein the outlet (22) comprises a controllable hatch (23) movable between a blocking state and an open state.

Example 14: The flotation device (30) of any preceding example, wherein the outlet (22) is arranged below a terminal circuit (15) of a lowest battery module (12-1) from among the one or more battery modules (12).

Example 15: The flotation device (30) of Example 14, wherein the outlet (22) is arranged adjacent to a bottom (B) of the battery pack (10).

Example 16: A liquid coolant pipe (20) comprising the flotation device (30) of any of Examples 1-15.

Example 17: A battery pack (10) comprising at least one battery module (12) and the liquid coolant pipe (20) of Example 16.

Example 18: A high-voltage component (40) comprising the battery pack (10) of Example 17.

Example 19: An energy storage system (50) comprising the high-voltage component (40) of Example 18.

Example 20: A vehicle (1) comprising the energy storage system (50) of Example 19.

Example 21: A method (200) for thermal runaway management, comprising accommodating (210) liquid coolant in a liquid coolant pipe (20) of a battery pack (10) having one or more battery modules (12); attaching (220) a flotation device (30) to the liquid coolant pipe (20), wherein the flotation device (30) comprises a first portion (32) arranged in fluid communication with liquid coolant accommodated by the liquid coolant pipe (20), the first portion (32) causing selective blocking or opening of an outlet (22) leading inside the battery pack (10), a second portion (34) arranged inside the battery pack (10) and being floatable, and a third portion (36) interconnecting the first and second portions (32, 34), wherein the third portion (36) is configured to adjust a position of the first portion (32) based on a position of the second portion (34).

The terminology used herein is for the purpose of describing particular aspects only and is not intended to be limiting of the disclosure. As used herein, the singular forms "a," "an," and "the" are intended to include the plural forms as well, unless the context clearly indicates otherwise. As used herein, the term "and/or" includes any and all combinations of one or more of the associated listed items. It will be further understood that the terms "comprises," "comprising," "includes," and/or "including" when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as "below" or "above" or "upper" or "lower" or "horizontal" or "vertical" may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being "connected" or "coupled" to another element, it can be directly connected or coupled to the other element, or intervening elements may be present. In contrast, when an element is referred to as being "directly connected" or "directly coupled" to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A flotation device for attachment to a liquid coolant pipe of a battery pack having one or more battery modules, the flotation device comprising:
a first portion arranged in fluid communication with liquid coolant accommodated by the liquid coolant pipe, the first portion causing selective blocking or opening of an outlet leading inside the battery pack;
a second portion arranged inside the battery pack and being floatable;
a third portion interconnecting the first and second portions, wherein the third portion is configured to adjust a position of the first portion based on a position of the second portion; and
a pipe extension portion, wherein the first portion, the outlet, and at least parts of the third portion is arranged in the pipe extension portion.

2. The flotation device of claim 1, wherein the third portion adjusts the position of the first portion to physically block the outlet.

3. The flotation device of claim 1, further comprising an electronic switch, wherein the third portion adjusts the position of the first portion to activate the electronic switch to trigger a block of the outlet.

4. The flotation device of claim 1, wherein the pipe extension portion is retrofitted to the liquid coolant pipe such that an opening for liquid coolant is formed at an end of the pipe extension portion.

5. The flotation device of claim 1, further comprising an actuator configured to control a release of liquid coolant through the outlet.

6. The flotation device of claim 5, wherein the actuator is integrated into the flotation device.

7. The flotation device of claim 5, wherein the actuator is configured to be controlled by a battery management system of the battery pack based on battery data indicating the presence of a thermal runaway event.

8. The flotation device of claim 5, wherein the actuator comprises a fusible material having a melting point or sublimation point corresponding to a temperature threshold.

9. The flotation device of claim 1, wherein the outlet comprises a fusible material having a melting point or sublimation point corresponding to a temperature threshold.

10. The flotation device of claim 1, wherein the second portion comprises a material having a density lower than that of the liquid coolant.

11. The flotation device of claim 5, wherein the second portion comprises an elongated member having a lower surface that is generally planar with a surface of the released liquid coolant.

12. The flotation device of claim 1, wherein the outlet comprises a controllable hatch movable between a blocking state and an open state.

13. The flotation device of claim 1, wherein the outlet is arranged below a terminal circuit of a lowest battery module from among the one or more battery modules.

14. The flotation device of claim 13, wherein the outlet is arranged adjacent to a bottom of the battery pack.

15. A battery pack comprising at least one battery module and a liquid coolant pipe comprising the flotation device of claim 1.

16. A high-voltage component comprising the battery pack of claim 15.

17. An energy storage system comprising the high-voltage component of claim 16.

18. A vehicle comprising the energy storage system of claim 17.

19. A method for thermal runaway management, comprising:
accommodating liquid coolant in a liquid coolant pipe of a battery pack having one or more battery modules; and
attaching a flotation device to the liquid coolant pipe, wherein the flotation device comprises:
a first portion arranged in fluid communication with liquid coolant accommodated by the liquid coolant pipe, the first portion causing selective blocking or opening of an outlet leading inside the battery pack,
a second portion arranged inside the battery pack and being floatable,
a third portion interconnecting the first and second portions, wherein the third portion is configured to adjust a position of the first portion based on a position of the second portion, and
a pipe extension portion, wherein the first portion, the outlet, and at least parts of the third portion is arranged in the pipe extension portion.
